(19) United States
(12) Patent Application Publication
(10) Pub. No.: US 2026/0210325 A1
(43) Pub. Date: Jul. 23, 2026

(54) SYSTEMS AND METHODS FOR A MULTI-USE PUMPED STORAGE HYDROPOWER SYSTEM

(71) Applicant: River Connectivity Solutions, LLC, Bainbridge Island, WA (US)

(72) Inventors: Andrew Peters, Bainbridge Island, WA (US); Andrew Blystra, Camp Hill, PA (US)

(21) Appl. No.: 19/455,729

(22) Filed: Jan. 21, 2026

Related U.S. Application Data
(60) Provisional application No. 63/748,039, filed on Jan. 22, 2025.

(51) Int. Cl. F03B 13/06; A01K 61/13; A01K 63/04; C02F 1/00; G05D 7/06; C02F 103/20

(52) U.S. Cl. CPC F03B 13/06; A01K 61/13; A01K 63/045; A01K 63/047; C02F 1/004; C02F 1/008; G05D 7/0641; C02F 2103/20; C02F 2201/005; C02F 2209/40

(57) ABSTRACT

The disclosed technology includes systems related to a dual-use water management system. The dual-use water management system includes an upper reservoir at a first elevation. The system includes a lower reservoir positioned at a second elevation lower than the upper reservoir. The system further includes a powerhouse in fluid communication with the upper reservoir and the lower reservoir via at least one penstock, and the powerhouse configured to pump water from the lower reservoir to the upper reservoir and to generate power from water flowing from the upper reservoir to the lower reservoir by directing water through a turbine to drive a generator. The system also includes an aquaculture facility positioned at a third elevation, and the aquaculture facility being configured to maintain water quality parameters suitable for aquatic life.

### CROSS-REFERENCE TO RELATED APPLICATIONS

This application claims the benefit of priority under 35 U.S.C. § 119 to prior filed U.S. Provisional Patent Application No. 63/748,039 filed on January 22, 2025, the entire contents of which is hereby incorporated by reference as if set forth in full herein.

### FIELD OF INVENTION

The various embodiments of the present disclosure relate generally to enhancements to pumped storage hydropower systems, and more particularly to dual-use pumped hydropower and aquaculture systems.

### BACKGROUND

Pumped storage hydropower (PSH) is a type of hydroelectric energy storage. It is a configuration of two or more water reservoirs at different elevations that can generate power as water moves down from one to the other (discharge) due to gravity, passing through a turbine. The system can use power produced at times of high power production, for example during peak solar hours, to pump water back into the upper reservoir (recharge). In this way, PSH acts as a form of gravity battery because it can store power and then release it when needed.

Traditional PSH systems are typically limited to single-use configurations, which restrict their functionality to storing energy, stabilizing the grid, and supplying power during peak demand periods. While highly effective in these roles, PSH facilities often have infrastructure limited to one primary use, missing opportunities to serve broader community needs and support additional applications involving one or more reservoirs.

PSH facilities are highly intensive uses of land and water, and regulatory requirements can pose barriers to their implementation. As sustainability and environmentally friendly power becomes increasingly important alongside growing power needs, there is a need for flexible PSH systems capable of integrating secondary uses without compromising primary energy generation functions.

Recirculating Aquaculture Systems (RAS) are closed-loop systems used for fish production that recirculate and treat water to maintain suitable conditions for aquaculture operations. RAS facilities typically require water circulation and treatment infrastructure, which can involve energy-intensive pumping systems to move water through rearing ponds or tanks.

Integrating multiple uses within a single infrastructure footprint presents challenges related to water management, flow control, water quality maintenance, and operational coordination. Systems that attempt to combine energy generation with secondary water uses may encounter difficulties in maintaining compatibility between different operational requirements while minimizing water loss and environmental impact.

Thus, there is a clear need for an improved water-management system that effectively utilizes water from pumped storage hydropower with a recirculating aquaculture system. These and other problems are addressed by the technology disclosed herein.

### SUMMARY

The disclosed technology can relate to a dual-use water management system comprising an upper reservoir, a lower reservoir, a powerhouse, and an aquacultural facility. The upper reservoir can be positioned at a first elevation, and the lower reservoir can be positioned at a second elevation lower than the upper reservoir.

The powerhouse can be in fluid communication with the upper reservoir and the lower reservoir via at least one penstock. The powerhouse can be configured to pump water from the lower reservoir to the upper reservoir and to generate power from water flowing from the upper reservoir to the lower reservoir by directing water through a turbine to drive a generator.

The aquaculture facility can be positioned at a third elevation between the upper reservoir and the lower reservoir and in fluid communication with the upper reservoir, lower reservoir, and powerhouse. The aquaculture facility can be configured to maintain water quality parameters suitable for aquatic life.

The dual-use water management system can further comprise a water treatment system in fluid communication with the upper reservoir, lower reservoir, and the powerhouse. The water treatment system can be configured to comprise a closed-loop water treatment system that filters and purifies water exiting the aquaculture facility before returning the treated water to the lower reservoir. The water treatment system can comprise processes for removing solids and other adulterants from the water.

The water treatment system can be configured to process water from the upper reservoir before the water enters the aquaculture facility.

The water treatment system can be configured to filter water exiting the aquaculture facility before returning it to the lower reservoir.

The water treatment system can be configured to prevent a spread of disease and/or pathogens.

The aquaculture facility can comprises rearing ponds or tanks configured to maintain water quality parameters.

The dual-use water can further comprise flow control mechanisms configured to manage water distribution and timing between the upper reservoir, the aquaculture facility, and the powerhouse. The flow control mechanisms can comprise automated valves and are controlled via predictive algorithms configured to coordinate water flow throughout the dual-use water management system. The predictive algorithms can be configured to dynamically adjust water distribution based on real-time demand and environmental conditions.

The dual-use water can further comprise at least one sensor configured to continuously monitor water quality parameters including at least one of pH, turbidity, temperature, nutrient levels, or a combination thereof. The at least one sensor can be configured to monitor at least water use, water loss, inflow, outflow, or a combination thereof.

The dual-use water can further comprise at least one additional penstock configured to be used in at least one additional reservoir or aquaculture center.

According to another aspect of the present disclosure, the disclosed technology includes an automated flow monitoring system that comprises a plurality of sensors, a flow meter, and a control system. The plurality of sensor can be configured to continuously monitor water quality parameters.

The flow meter can be configured to track water inflow and outflow to maintain balanced levels in an upper reservoir at a first elevation, a lower reservoir at a second elevation lower than the first elevation, and an aquaculture center at a third elevation between the first elevation and the second elevation.

The control system can be configured to implement operational rules for controlling (1) water flow for pumped storage hydropower energy generation and (2) water filtration for maintaining water quality parameters suitable for aquatic life, the control system configured to dynamically adjust flow rates based on demand cycles, environmental conditions, and aquaculture requirements.

The present disclosure relates to combined PSH and Recirculating Aquaculture Systems (RAS). An exemplary embodiment of the present disclosure provides a dual-use water management system for integrating Pumped Storage Hydropower (PSH) with Recirculating Aquaculture Systems (RAS). In any of the embodiments disclosed herein, the dual-use water management system can include an upper reservoir and a lower reservoir connected by one or more primary penstock(s) and a separate conduit system for water movement. In any of the embodiments disclosed herein, the dual-use water management system can include a conduit to deliver gravity-fed water from the upper reservoir to an aquaculture facility, minimizing the need for additional energy inputs. In any of the embodiments disclosed herein, the dual-use water management system can include a discharge system that treats and returns water from the aquaculture facility to the lower reservoir, ensuring minimal water loss and maintaining compatibility with PSH operations.

Another embodiment of the present disclosure provides a multi-use conduit and penstock system. In any of the embodiments disclosed herein, the multi-use conduit and penstock system can include a multi-use conduit and penstock system configured to manage water flow for simultaneous energy generation and secondary uses including: one or more penstocks or conduits, flow control mechanisms to manage water distribution and timing, and flexible, modular conduit system that supports additional applications. In any of the embodiments disclosed herein, the one or more penstocks or conduits can connect the upper reservoir to the powerhouse for energy generation and supply water to the aquaculture facility, supporting concurrent energy generation and fish production without operational conflicts. In any of the embodiments disclosed herein, the flow control mechanisms can manage water distribution and timing, ensuring seamless integration of secondary uses without impacting the primary energy generation process. In any of the embodiments disclosed herein, the flexible conduit system can support additional applications, such as cooling, without requiring significant modifications to the primary infrastructure.

Another embodiment of the present disclosure provides an energy efficiency and gravity-fed water system for managing water flow in aquaculture operations. In any of the embodiments disclosed herein, the energy efficiency and gravity-fed water system can include a gravity-fed water system that delivers water from the upper reservoir to the aquaculture facility, using natural flow to provide circulation through the aquaculture infrastructure, thereby minimizing the need for energy-intensive pumping systems. In any of the embodiments disclosed herein, the energy efficiency and gravity-fed water system can operate continuously, ensuring a consistent water supply to the aquaculture facility’s rearing ponds and/or tanks. In any of the embodiments disclosed herein, water that has circulated through the aquaculture facility can be treated and then returned to the lower reservoir, where it can be pumped back to the upper reservoir as part of the regular PSH cycle. In any of the embodiments disclosed herein, the system can ensure integrated water flow management for aquaculture without interfering with or negatively impacting PSH energy generation activities.

Another embodiment of the present disclosure provides a water treatment and recirculation system configured for use in an integrated PSH and aquaculture facility. In any of the embodiments disclosed herein, the water treatment and recirculation system can include a closed-loop water treatment system that filters and purifies water exiting the aquaculture facility before returning it to the lower reservoir, reducing the potential for disease or pathogen spread. In any of the embodiments disclosed herein, the water treatment and recirculation system can include processes and/or mechanisms for removing solids and other adulterants as needed, ensuring that returned water meets quality standards required for reuse in PSH energy generation. In any of the embodiments disclosed herein, the water treatment and recirculation system can include efficiency features that support seamless integration within the PSH cycle, including minimal water loss, low electrical consumption, and recovery of valuable waste products, all contributing to sustainable operation with minimal environmental impact.

Another embodiment of the present disclosure provides that any of the systems disclosed herein be modular, scalable, and multi-use. In any of the embodiments disclosed herein, the system can be configured to be adaptable to PSH as a non-project use of land and water, such as aquaculture, without requiring significant reconfiguration of the primary energy infrastructure. In any of the embodiments disclosed herein, modular components can allow for scalable capacity adjustments to meet varying regional demands for energy generation, water flow, and fish production. In any of the embodiments disclosed herein, the systems can include a water supply conduit that can be easily expanded or reconfigured to accommodate future changes in operational needs or secondary land and water applications.

Another embodiment of the present disclosure provides an automated flow monitoring system for managing water distribution and quality between PSH and aquaculture. In any of the embodiments disclosed herein, the automated flow monitoring system can include sensors that continuously monitor water quality parameters, such as pH, turbidity, temperature, and nutrient levels, to ensure conditions meet the requirements for aquaculture and PSH reuse. In any of the embodiments disclosed herein, the automated flow monitoring system can include a means for monitoring water use and loss as well as tracking inflow and outflow to maintain efficient circulation and balanced reservoir levels. In any of the embodiments disclosed herein, the automated flow monitoring system can include operational rules to prevent interference with PSH energy generation, including real-time adjustments to aquaculture water flow based on PSH operating constraints to ensure continuous operation of both systems without conflict. In any of the embodiments disclosed herein, the automated flow monitoring system can include additional monitoring features that dynamically adjust flow rates and temperature to support efficient PSH operation and optimal conditions for aquaculture.

Another embodiment of the present disclosure provides a method for low-impact environmental installation of any of the systems disclosed herein. In any of the embodiments disclosed herein, the method can include ensuring compliance with federal, state, and local regulatory requirements, with the Recirculating Aquaculture System (RAS) facility considered a non-project use of land and water. In any of the embodiments disclosed herein, the method can include implementing of low-impact installation measures, including but not limited to erosion control, sediment management, and habitat protection, to minimize ecological disruption. In any of the embodiments disclosed herein, the method can include employing filtration and water treatment systems configured to maintain water quality suitable for both aquaculture habitat and Pumped Storage Hydropower (PSH) operational standards, ensuring clean water inflow for fish health and clean return water for PSH functionality. In any of the embodiments disclosed herein, the method can include configuring any of the systems herein to meet environmental compliance requirements by tracking necessary metrics, ensuring alignment with regulatory and operational standards for sustainable energy and aquaculture operations. Another embodiment of the present disclosure provides a real-time Supervisory Control and Data Acquisition (SCADA) monitoring system configured to track and optimize the performance of the integrated PSH/aquaculture system. In any of the embodiments disclosed herein, the monitoring system can include sensors that continuously monitor critical parameters, including water quality, flow rates, energy output, and environmental impact, with adaptability for additional metrics as needed. In any of the embodiments disclosed herein, a central control system can generate automated compliance reports for regulatory standards (e.g., FERC) and provide priority-based alerts for potential disruptions, enabling timely intervention to prevent system downtime or regulatory non-compliance. In any of the embodiments disclosed herein, the monitoring system can include optimization features that analyze historical and real-time data to dynamically adjust operational parameters, such as flow rates and energy output, based on demand cycles, environmental conditions, and aquaculture requirements. This adaptive control can maximize resource efficiency and maintains ideal conditions for PSH and aquaculture operations.

Any of the systems and methods disclosed herein can be configured to comply with U.S. and international regulatory standards and commercial operations, integrate seamless sustainable deployment and operations across diverse jurisdictions, and provide for modularity enabling easy modifications to the systems and methods for the purpose of obtaining funding, grants, abatements, incentives, or the like.

Additional features, functionalities, and applications of the disclosed technology are discussed herein in more detail.

### BRIEF DESCRIPTION OF FIGURES

Implementations, features, and aspects of the disclosed technology are described in detail herein and are considered a part of the claimed disclosed technology. Other implementations, features, and aspects can be understood with reference to the following detailed description, accompanying drawings, and claims. Wherever possible, the same reference numbers are used throughout the drawings to refer to the same or like members of an embodiment. Reference will now be made to the accompanying figures and flow diagrams, which are not necessarily drawn to scale.

FIG. 1 illustrates a schematic view of a dual-use water management system, in accordance with exemplary embodiments of the present invention.

FIG. 2 illustrates a pictorial isometric view of a dual-use water management system, in accordance with exemplary embodiments of the present invention.

FIG. 3 illustrates a schematic view of a dual-use water management system, in accordance with exemplary embodiments of the present invention.

FIG. 4 illustrates an example controller configured to control the dual-use water management system, in accordance with exemplary embodiments of the present invention.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Aspects of the disclosed technology will be described more fully hereinafter with reference to the accompanying drawings. This disclosed technology can, however, be embodied in many different forms and should not be construed as limited to the examples set forth therein.

In the following description, numerous specific details are set forth. However, it is to be understood that various examples of the disclosed technology can be practiced without these specific details. In other instances, well-known methods, structures, and techniques have not been shown in detail in order to not obscure an understanding of this description. References to “one embodiment,” “an embodiment,” “example embodiment,” “some embodiments,” “certain embodiments,” “various embodiments,” “one example,” “an example,” “some examples,” “certain examples,” “various examples,” etc., indicate that the example(s) of the disclosed technology so described can include a particular feature, structure, or characteristic, but not every implementation of the disclosed technology necessarily includes the particular feature, structure, or characteristic.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

By “comprising” or “containing” or “including,” etc. is meant that at least the named compound, member, particle, or method step is present in the composition or article or method, but does not exclude the presence of other compounds, materials, particles, method steps, even if the other such compounds, material, particles, method steps have the same function as what is named.

Herein, the use of terms such as “having,” “has,” “including,” “includes,” etc. are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter. Additionally, the components described herein may apply to any other component within the disclosure. Merely discussing a feature or component in relation to one embodiment does not preclude the feature or component from being used or associated with another embodiment.

The present disclosure relates to a dual-use water management system configured to integrate pumped storage hydropower (PSH) with recirculating aquaculture systems (RAS). PSH is a type of hydroelectric energy storage that utilizes two or more water reservoirs at different elevations to generate power as water moves from a higher elevation reservoir to a lower elevation reservoir through a turbine. During periods of excess power availability, water may be pumped from the lower reservoir back to the upper reservoir, allowing the PSH system to function as a form of energy storage.

The dual-use water management system described herein may combine energy storage functionality with sustainable fish production within a unified infrastructure. In some cases, water from an upper reservoir may be delivered to an aquaculture facility using gravity-fed flow, reducing reliance on energy-intensive pumping mechanisms. The aquaculture facility may support fish production within rearing ponds or tanks that maintain appropriate water quality and nutrient levels for fish health.

In some cases, water that has circulated through the aquaculture facility may be treated and returned to a lower reservoir, where the water may be pumped back to the upper reservoir as part of a regular PSH cycle. This closed-loop configuration may minimize water loss and maintain compatibility between aquaculture operations and PSH energy generation activities.

The dual-use water management system may utilize automated flow control, real-time monitoring systems (e.g., controller), and modular components to optimize water use across multiple applications. In some cases, the system may reduce installation complexity and environmental impact while extending the utility of PSH infrastructure beyond traditional energy storage applications. The system may be configured to comply with regulatory standards and may support evolving community and environmental needs by integrating food production with renewable energy storage within a single adaptable framework.

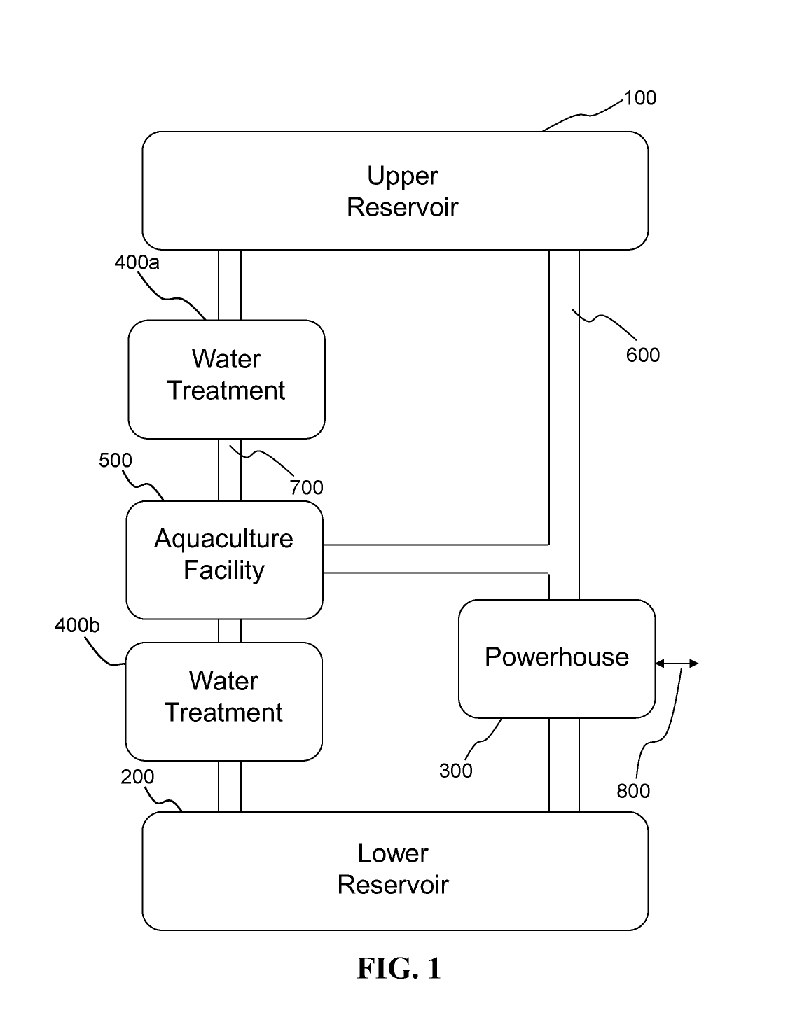

As shown in FIGS. 1-3, an exemplary embodiment of the present invention provides a dual-use water management system for integrating Pumped Storage Hydropower (PSH) with Recirculating Aquaculture Systems (RAS). In various embodiments, the system may include an upper reservoir 100 positioned at a first elevation, a lower reservoir 200 positioned at a second elevation lower than the first elevation, and a powerhouse 300 that facilitates energy generation and water pumping operations between the upper reservoir 100 and the lower reservoir 200. The system may further include an inlet 400a of a water treatment system 400 and/or an outlet 400b of a water treatment system 400 configured to process water entering and exiting an aquaculture facility 500, respectively. In one or more embodiments, at least one penstock 600 may connect the upper reservoir 100 to the powerhouse 300 to enable water flow for energy generation. In various embodiments, at least one additional penstock (e.g., conduit) 700 may deliver water from the upper reservoir 100 to the inlet 400a of the water treatment system and subsequently to the aquaculture facility 500. In various embodiments, a power line 800 may operably couple the powerhouse 300 to external systems for transmission of generated electricity or receipt of power for pumping water from the lower reservoir 200 to the upper reservoir 100.

With reference to FIG. 1, in various embodiments, the system may be arranged in a tiered elevation configuration such that, the upper reservoir 100 may be positioned at a higher elevation than the aquaculture facility 500 and/or the lower reservoir 200. In various embodiments, the aquaculture facility 500 may be positioned at a higher elevation than the lower reservoir 200. This tiered elevation arrangement may enable gravity-fed water delivery from the upper reservoir 100 through the at least one additional penstock (e.g., conduit) 700 to the aquaculture facility 500, reducing reliance on energy-intensive pumping mechanisms for aquaculture operations.

In various embodiments, the water treatment system may receive water from the upper reservoir 100 at the inlet 400a and process the water before the water enters the aquaculture facility 500, ensuring appropriate water quality for aquaculture operations. Water exiting the aquaculture facility 500 may pass through the outlet 400b of the water treatment system, which may filter and purify the water before the water is returned to the lower reservoir 200. The powerhouse 300 may pump water from the lower reservoir 200 to the upper reservoir 100 during periods of excess energy availability and may generate power during reverse operation when water flows from the upper reservoir 100 to the lower reservoir 200 through the penstock 600. In one or more embodiments, the dual-use water management system may include an upper reservoir 100 and a lower reservoir 200 positioned at different elevations to facilitate both energy storage and aquaculture operations. The upper reservoir 100 may be positioned at a higher elevation relative to the lower reservoir, creating a hydraulic head that enables gravity-driven water flow between the two reservoirs. In some cases, the elevation difference between the upper reservoir 100 and the lower reservoir may be selected to provide sufficient hydraulic pressure for energy generation through turbine operation.

The upper reservoir 100 may serve as a primary water storage component for the PSH system. In some cases, the upper reservoir 100 may store water during periods when excess energy is available, allowing the stored water to be released for energy generation during periods of high energy demand. The upper reservoir 100 may also serve as a water source for aquaculture operations, with water being delivered from the upper reservoir 100 to an aquaculture facility through a gravity-fed conduit system.

The lower reservoir 200 may receive water that has flowed from the upper reservoir 100 100 through the PSH system or through the aquaculture facility 500. In some cases, the lower reservoir 200 may function as a collection basin for water that has passed through turbines during energy generation operations. The lower reservoir 200 may also receive treated water from the aquaculture facility 500 after the water has been processed through water treatment systems to remove impurities and maintain water quality standards. In various embodiments, the dual-use water management system may include a powerhouse 300 configured to facilitate reversible pump-turbine operation between the upper reservoir 100 and the lower reservoir 200. The powerhouse 300 may be operably coupled to at least one turbine 320 power configured to drive at least one generator 310. In some cases, the powerhouse 300 may pump water from the lower reservoir 200 to the upper reservoir 100 during periods of excess energy availability, such as during peak solar hours or periods of low energy demand. In various embodiments, the powerhouse 300 may generate power in reverse operation when water flows from the upper reservoir 100 to the lower reservoir 200. During reverse operation, water may pass through at least one turbine 320 within the powerhouse 300, converting the gravitational potential energy of the water into electrical energy. The generated electrical energy may be transmitted through the power line to external systems or to an electrical grid for distribution. In various embodiments, the reversible pump-turbine operation may allow the PSH system to function as a form of energy storage, storing excess energy during periods of high production and releasing stored energy during periods of high demand. In some embodiments, the reversible operation may be controlled based on energy demand cycles, grid requirements, or availability of renewable energy sources. The powerhouse 300 may be configured to switch between pumping mode and generation mode based on operational requirements and energy market conditions.

The dual-use water management system may include at least one penstock 600 connecting the upper reservoir 100 to the powerhouse 300 to enable water flow for energy generation. The at least one penstock 600 may be configured as a conduit or channel that conveys water from the upper reservoir 100 to at least one turbine 320 within the powerhouse 300 during energy generation operations. In various embodiments, the at least one penstock 600 may be sized and positioned to accommodate the hydraulic head created by the elevation difference between the upper reservoir 100 and the powerhouse 300, allowing water to flow under pressure through the penstock to at least one turbine 320 power configured to drive at least one generator 310.

In various embodiments, the at least one penstock 600 may provide a pathway for water to flow from the aquaculture facility directly into the penstock and back to the upper reservoir 100. In some cases, the aquaculture facility 500 may be connected to the at least one penstock 600 through a conduit or channel that allows treated water exiting the aquaculture facility to enter the penstock system. In various embodiments, water that has circulated through the aquaculture facility 500 may be directed into the at least one penstock 600 during periods when the powerhouse 300 is operating in pumping mode, allowing the water to be pumped back to the upper reservoir 100 from the lower reservoir 200.

In various embodiments, the dual-use water management system may further include at least one flow control mechanism (not depicted) configured to regulate the timing and volume of water entering the penstock from the aquaculture facility. In one or more embodiments, the at least one flow control mechanism may be configured to coordinate water flow from the aquaculture facility 500 with PSH operations, allowing water to enter the at least one penstock at times that do not interfere with energy generation activities. The at least one penstock 600 may further provide operational flexibility by enabling multiple water circulation routes within the integrated PSH and aquaculture system.

In one or more embodiments, the dual-use water management system may include at least one addition penstock (e.g., conduit) 700 configured to deliver gravity-fed water from the upper reservoir 100 to the aquaculture facility. The at least one addition penstock (e.g., conduit) 700 may leverage natural elevation differences between the upper reservoir 100 and the aquaculture facility 500 to provide water flow without requiring energy-intensive pumping mechanisms. In some embodiments, the at least one addition penstock (e.g., conduit) 700 may be positioned to take advantage of the hydraulic head created by the elevation difference, allowing water to flow from the upper reservoir 100 to the aquaculture facility under the influence of gravity alone.

The gravity-fed water delivery through the at least one addition penstock (e.g., conduit) 700 may minimize the need for additional energy inputs to support aquaculture operations. In various embodiments, the natural flow of water through the at least one addition penstock (e.g., conduit) 700 may provide sufficient water circulation through the aquaculture infrastructure, reducing or eliminating the requirement for dedicated pumping systems to supply water to rearing ponds or tanks within the aquaculture facility. The gravity-fed configuration may contribute to overall energy efficiency of the integrated system by utilizing the existing elevation arrangement of the PSH infrastructure to support secondary water uses.

The at least one penstock 600 and/or at least one addition penstock (e.g., conduit) 700 may be configured as a flexible and modular system that supports additional applications beyond aquaculture operations. In one or more embodiments, the at least one penstock 600 and/or at least one addition penstock (e.g., conduit) 700 may be configured to supply water for industrial cooling applications without requiring substantial modifications to the primary PSH infrastructure. The modular configuration of the at least one penstock 600 and/or at least one addition penstock (e.g., conduit) 700 may allow for connection of additional water delivery branches or outlets to serve various secondary applications while maintaining the primary water flow pathways for PSH energy generation and aquaculture operations. The flexible architecture of the at least one penstock 600 and/or at least one addition penstock (e.g., conduit) 700 may enable adaptation to site-specific requirements and operational conditions. In various embodiments, the at least one penstock 600 and/or at least one addition penstock (e.g., conduit) 700 may include modular components that can be connected, disconnected, or rearranged to accommodate different water delivery configurations. The modular components may include pipe sections, fittings, valves, and connection points that allow for reconfiguration of water flow pathways as operational needs change over time.

In one or more embodiments, the at least one penstock 600 and/or at least one addition penstock (e.g., conduit) 700 may be configured to be easily expanded or reconfigured to accommodate future changes in operational needs or secondary land and water applications. In various embodiments, the at least one penstock 600 and/or at least one addition penstock (e.g., conduit) 700 may include provisions for adding additional conduit sections or branches to extend water delivery to new locations or to increase water flow capacity. The expandable configuration may allow the system to scale according to changing demands for water supply, whether for increased aquaculture production, additional industrial cooling capacity, or other secondary water uses.

The dual-use water management system can include a multi-use conduit and penstock system. The multi-use conduit and penstock system can optimize water flow distribution for both primary energy generation and secondary uses. Flow control mechanisms, including automated valves and predictive algorithms, manage timing and distribution to each application, ensuring continuous operation without conflicts. These controls dynamically adjust flows based on real-time demand and environmental conditions, allowing the system to prioritize PSH energy storage or aquaculture needs as required. The conduits can be configured to accommodate additional applications, such as industrial cooling, without requiring substantial infrastructure modifications. This flexible architecture allows the system to scale according to site-specific needs, maximizing resource efficiency and supporting a range of sustainable water uses within a unified structure.

In various embodiments, the dual-use water management system may include water treatment system comprising an inlet 400a and/or an outlet 400b such that, the water treatment system may be configured to maintain water quality suitable for both aquaculture habitat and PSH operational standards. The inlet 400a of the water treatment system may process water from the upper reservoir 100 before the water enters the aquaculture facility 500, conditioning the water to meet parameters appropriate for fish health and aquaculture production. In various embodiments, the inlet 400a of the water treatment system may adjust water temperature, remove suspended particles, or modify chemical characteristics of the water to create conditions suitable for the species being cultivated within the aquaculture facility. In various embodiments, the outlet 400b of the water treatment system may include a closed-loop water treatment system that filters and purifies water exiting the aquaculture facility 500 before returning the water to the lower reservoir 200. The closed-loop configuration may reduce the potential for disease or pathogen spread by treating water before the water re-enters the PSH system. In various embodiments, the closed-loop water treatment system may include multiple treatment stages configured to address different types of contaminants or water quality parameters that may be affected by aquaculture operations. The outlet 400b of the water treatment system may include processes and mechanisms for removing solids and other adulterants as needed, ensuring that returned water meets quality standards required for reuse in PSH energy generation. In some cases, the solid removal processes may include mechanical filtration, sedimentation, or screening to separate particulate matter from the water stream. The removal of solids may prevent accumulation of organic material within the lower reservoir 200 and may maintain water clarity and quality for subsequent PSH operations.

The outlet 400b of the water treatment system may include biological filtration processes configured to remove dissolved organic compounds and nitrogenous waste products generated by fish metabolism within the aquaculture facility. In some embodiments, biological filtration may utilize bacterial communities to convert ammonia and nitrite compounds into less harmful nitrate compounds. The biological treatment processes may reduce the concentration of potentially harmful substances in the water before the water is returned to the lower reservoir 200. The outlet 400b of the water treatment system may further include at least one disinfection process configured to reduce or eliminate pathogens that may be present in water exiting the aquaculture facility. In some embodiments, disinfection may be accomplished through ultraviolet light treatment, ozonation, or other methods that inactivate microorganisms without introducing chemical residues into the water stream. The disinfection processes may protect both the aquaculture facility from disease recirculation and the PSH system from biological contamination.

In various embodiments, the dual-use water management system incorporates a closed-loop water treatment and filtration mechanism that ensures water quality standards are maintained for both PSH and aquaculture operations. The filtration system is designed to remove impurities, solids, and potential pathogens as water exits the aquaculture facility, aligning with regulatory standards and protecting both fish health and PSH operations. This filtration mechanism is adaptable, with customizable treatment stages to meet site-specific water quality and environmental requirements. By returning treated water to the lower reservoir, the system minimizes water loss, reduces the need for additional makeup water, and enhances resource efficiency, all within a closed-loop design that supports sustainable operation and reduces ecological impact. The water treatment system can be configured to carry out filtration cycles subservient to the power generation and storage needs of the PSH facility and other components of the system to efficiently utilize power from a generation source.

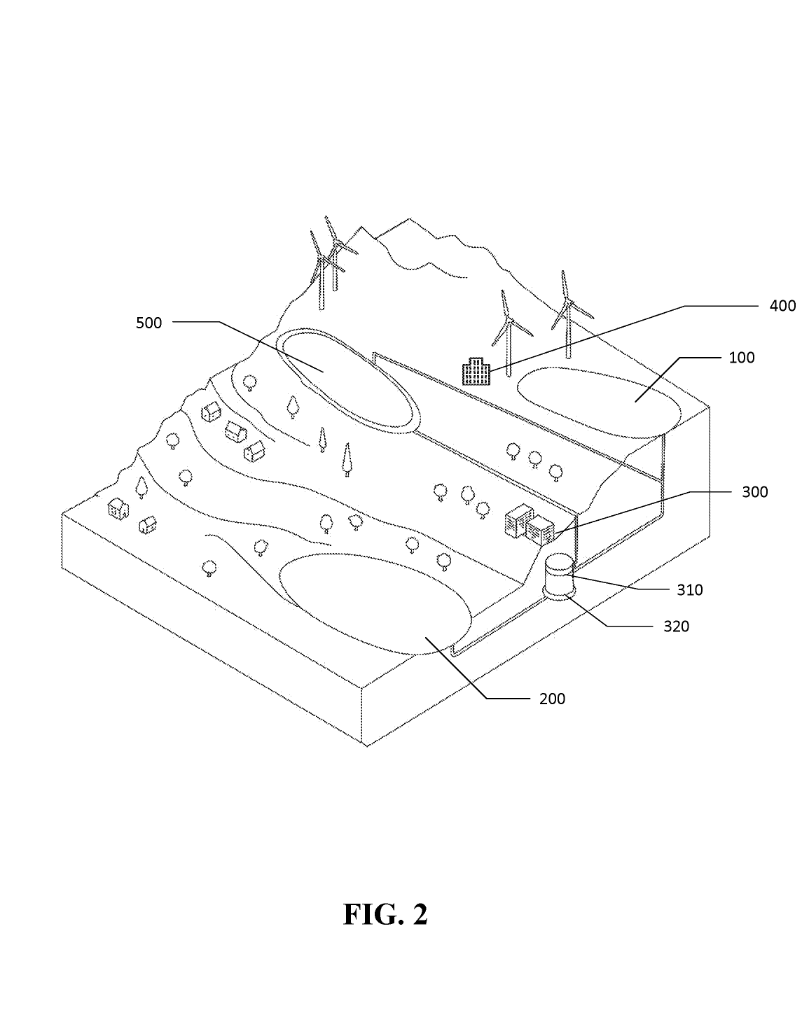

With reference to FIG. 2, a gravity-fed, closed-loop recirculating aquaculture facility may be situated at an elevation between the upper reservoir and the lover reservoir. The aquaculture facility includes an aquaculture pond or tank that receives water from the upper reservoir 100 through gravity-fed flow. The elevation positioning of the aquaculture facility 500 between the upper reservoir 100 and the lower reservoir 200 may enable the aquaculture system 500 to receive gravity-fed water from the upper reservoir 100 while allowing treated water to flow downward to the lower reservoir 200 after exiting the aquaculture facility 500.

A mechanical and biological filter may be positioned between the aquaculture facility 500 and the lower reservoir 200. The mechanical and biological filter may process water exiting the aquaculture facility 500 before the water enters the lower reservoir 200, removing solids, organic matter, and other substances that may accumulate during aquaculture operations. The positioning of the filter between the aquaculture facility 500 and the lower reservoir 200 may ensure that water returned to the lower reservoir 200 meets quality standards for reuse in pumped storage hydropower operations. The powerhouse 300 may be connected to the upper reservoir 100 and lower reservoir 200 through at least one penstock that facilitates water flow for energy generation. The powerhouse 300 may pump water from the lower reservoir 200 to the upper reservoir 100 during periods of excess energy availability and may generate power during reverse operation when water flows from the upper reservoir 100 to the lower reservoir 200 through turbines 320 within the powerhouse 300. In various embodiments, power transmission lines may extend from the powerhouse 300. The power transmission lines may transmit generated electrical power from the powerhouse 300 to an electrical grid or other distribution points. The power transmission infrastructure may also receive power from external sources, including the wind turbines, for use in pumping water from the lower reservoir 200 to the upper reservoir 100 during energy storage operations.

In various embodiments, the dual-use water management system may include an aquaculture facility 500 configured to support sustainable fish production operations within the integrated PSH and RAS infrastructure. The aquaculture facility 500 may be positioned at an intermediate elevation between an upper reservoir 100 and a lower reservoir 200, allowing the aquaculture facility 500 to receive gravity-fed water from the upper reservoir 100 while enabling treated water to flow downward to the lower reservoir 200 after exiting the aquaculture facility 500. In various embodiments, the aquaculture facility 500 may include rearing ponds and tanks configured to house fish populations during various growth stages. In various embodiments, the rearing ponds may be constructed as open or partially enclosed water bodies that provide space for fish to swim and grow under controlled conditions. The rearing tanks may be constructed as enclosed vessels that allow for more precise control of water parameters and fish density compared to open pond configurations. The aquaculture facility 500 may include a combination of rearing ponds and tanks to accommodate different species, growth stages, or production requirements within the same facility. In one or more embodiments, the rearing ponds and tanks may be configured to maintain water quality parameters suitable for fish health and growth. In various embodiments, the rearing ponds and tanks may include aeration systems configured to maintain dissolved oxygen levels within ranges appropriate for the species being cultivated. In one or more embodiments, the rearing ponds and tanks may be further configured to maintain nutrient levels appropriate for fish health and production.

In one or more embodiments, the aquaculture facility 500 may include water circulation systems configured to distribute incoming water throughout the rearing ponds and tanks. In some cases, the water circulation systems may include inlet structures positioned to introduce gravity-fed water into the rearing ponds and tanks at locations that promote uniform water distribution and mixing. The inlet structures may be configured to control flow rates and water velocities within the rearing ponds and tanks, creating water movement patterns that support fish health and waste removal. In one or more embodiments, the aquaculture facility 500 may be configured to support production of various fish species suitable for commercial aquaculture operations. In some embodiments, the aquaculture facility 500 may be configured to cultivate freshwater species that thrive in water conditions similar to those present in the PSH reservoirs. The selection of fish species may be based on water temperature ranges, water chemistry characteristics, market demand, and compatibility with the closed-loop water management approach of the integrated system.

In various embodiments, the intermediate elevation positioning of the aquaculture facility 500 may provide operational advantages for water management within the integrated system. In some embodiments, the elevation of the aquaculture facility 500 relative to the upper reservoir 100 may create sufficient hydraulic head to drive water flow through the aquaculture infrastructure without requiring pumping and/or the elevation of the aquaculture facility 500 relative to the lower reservoir 200 may allow treated water to flow by gravity from the aquaculture facility to the lower reservoir 200, further reducing energy requirements for water movement within the system.

In various embodiments, the system may further comprise at least one controller configured to track water quality parameters within the system. In various embodiments, the sensors may be positioned at various locations within the water flow pathways, including within conduits, water treatment systems, rearing ponds, tanks, and reservoirs, to provide comprehensive monitoring coverage across the system. In some cases, the at least one controller may include sensors positioned within the rearing ponds and tanks to measure temperature, dissolved oxygen, pH, ammonia, and other parameters relevant to fish health. The at least one controller may provide data that supports management decisions regarding feeding rates, water flow rates, and treatment intensity to maintain conditions suitable for fish production. In one or more embodiments, the sensors may be configured to monitor pH levels within the water to ensure conditions remain within ranges suitable for both aquaculture operations and PSH system compatibility.

In various embodiments, the system comprise sensors configured to measure the clarity of water at various points within the system, sensors configured to track water temperature throughout the integrated system, sensors configured to monitor nutrient levels within the water, sensors configured to monitor water use and loss throughout the integrated system, sensors configured to track inflow and outflow to maintain efficient circulation and balanced reservoir levels, and/or sensors configured to monitor water surface elevations.

The dual-use water management system may be configured as a modular, scalable, and multi-use system that supports adaptation to PSH as a non-project use of land and water without requiring significant reconfiguration of the primary energy infrastructure. In some embodiments, the modular configuration may allow secondary applications such as aquaculture to be integrated with existing PSH facilities through addition of modular components rather than through modification of core PSH infrastructure elements. The modular approach may enable PSH operators to add aquaculture capabilities or other secondary water uses to existing facilities while preserving the operational integrity and performance characteristics of the primary energy generation and storage systems. The modular configuration may include standardized interfaces and connection points that facilitate integration of secondary use components with the primary PSH infrastructure. In some embodiments, the standardized interfaces may include pipe connections, electrical connections, control system interfaces, and data communication links that allow modular components to be connected to the primary system using consistent connection protocols. The modular components may be configured to support incremental capacity expansion as demand for energy generation, water flow, or fish production increases over time. In some embodiments, additional penstock sections may be added to increase water delivery capacity to the aquaculture facility or to extend water delivery to additional secondary applications. Additional water treatment modules may be added to increase treatment capacity as aquaculture production expands or as water quality requirements become more stringent. Additional aquaculture tanks or rearing ponds may be added to increase fish production capacity in response to market demand or operational objectives.

The scalable capacity adjustments may enable the system to respond to varying regional demands without requiring replacement of existing infrastructure. In various embodiments, regions with higher energy demand may configure the system with larger penstock capacity and powerhouse 300 equipment while maintaining aquaculture operations at a scale appropriate for local market conditions. Regions with higher demand for fish production may configure the system with expanded aquaculture facilities and water treatment capacity while maintaining PSH operations at a scale appropriate for grid integration requirements. In one or more embodiments, the modular components may be configured for independent operation and maintenance, allowing individual components to be serviced or replaced without disrupting operation of the overall system

The dual-use water management system may utilize materials for long-term durability across diverse operational environments. In some embodiments, the materials may include corrosion-resistant alloys, high-density polymers, reinforced composites, and protective coatings that withstand exposure to water, biological materials, and environmental conditions encountered during system operation. The materials may be selected based on compatibility with both freshwater environments and the specific water chemistry conditions present within the PSH reservoirs and aquaculture facility.

The dual-use water management system may be configured to comply with regulatory standards applicable within the United States, including requirements established by the Federal Energy Regulatory Commission (FERC) for hydropower facilities. In some cases, the system may be designed and operated in accordance with FERC licensing requirements that govern construction, operation, and maintenance of hydropower projects. The FERC compliance may address requirements related to project safety, environmental protection, public access, and coordination with other water uses within the project area. The system may be configured to comply with FERC requirements regarding environmental protection, including requirements for protection of fish and wildlife resources, water quality, and cultural resources within the project area. The system may be configured to comply with FERC requirements regarding coordination with other water uses, including requirements for maintaining minimum flows, reservoir levels, or other operational parameters that protect downstream water users and aquatic resources. The system may be configured to comply with international regulatory standards applicable in jurisdictions outside the United States where the system may be deployed.

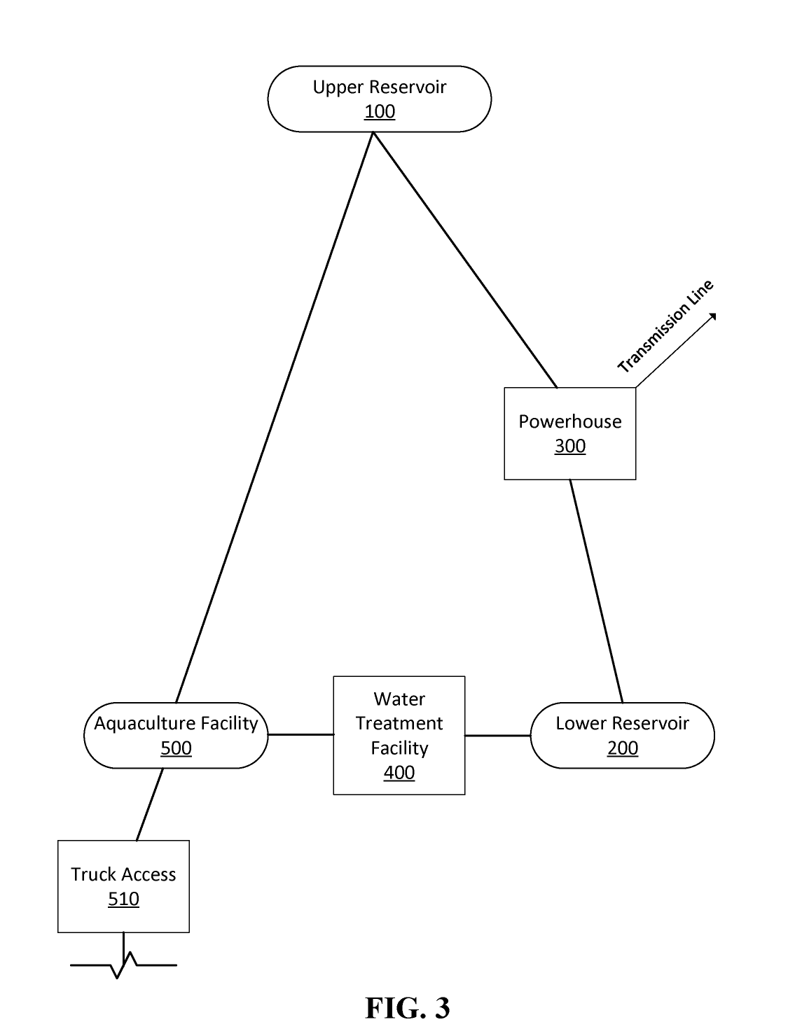

With reference to FIG. 3, a schematic view of the water flow paths in the PSH and RAS system is depicted. The schematic view provides a representation of the interconnections between system components and the pathways through which water circulates during combined energy storage and aquaculture operations. The schematic representation may facilitate understanding of the water flow relationships between the upper reservoir 100, aquaculture facility 500, water treatment system, lower reservoir 200, and powerhouse 300 within the integrated system.

The schematic view illustrates an aquaculture water supply penstock (e.g., penstock and/or conduit) that branches from the upper reservoir 100 to deliver gravity-fed water to the aquaculture facility 500. The aquaculture water supply penstock may be configured as a dedicated water delivery pathway that diverts a portion of water from the upper reservoir 100 toward the aquaculture facility 500 while the remaining water volume remains available for energy generation operations through the penstock. The branching configuration of the aquaculture water supply conduit may enable simultaneous water delivery to both the aquaculture facility and the powerhouse 300, supporting concurrent operation of aquaculture production and PSH energy generation without requiring water allocation decisions that would prioritize one application over the other.

With continued reference to FIG. 3, the aquaculture water supply penstock may leverage the elevation difference between the upper reservoir 100 and the aquaculture facility 500 to provide water flow without requiring pumping mechanisms. The gravity-fed water delivery through the aquaculture water supply penstock may reduce energy consumption associated with aquaculture operations by utilizing the natural hydraulic gradient created by the elevation arrangement of the PSH infrastructure. The aquaculture water supply penstock may be sized to provide sufficient water flow to meet the circulation requirements of the aquaculture facility while maintaining adequate water volume within the upper reservoir 100 for PSH operations.

In various embodiments, a water treatment system may be positioned between the aquaculture facility and the lower reservoir 200. The water treatment system may process water exiting the aquaculture facility 500 before the water enters the lower reservoir 200, removing contaminants, solids, and biological materials that may accumulate during fish production operations. The positioning of the water treatment system downstream of the aquaculture facility 500 and upstream of the lower reservoir 200 may ensure that water returned to the PSH system meets quality standards for reuse in energy generation operations.

The water treatment system may include filtration, biological treatment, and disinfection processes configured to address the range of water quality parameters that may be affected by aquaculture operations. In some embodiments, the water treatment system may remove suspended solids through mechanical filtration, reduce dissolved organic compounds through biological treatment processes, and inactivate pathogens through disinfection methods such as ultraviolet light treatment or ozonation. The water treatment system may be configured to operate continuously during aquaculture operations, processing water as the water exits the aquaculture facility and preparing the water for return to the lower reservoir 200.

As further shown in FIG. 3, in various embodiments, the system may further comprise a truck access 510 at the aquaculture facility 500 for transportation of fish, supplies, and equipment. The truck access 510 may provide a pathway for vehicles to reach the aquaculture facility 500 for delivery of fish feed, fingerlings, equipment, and other supplies required for aquaculture operations. The truck access 510 may also provide a pathway for transportation of harvested fish from the aquaculture facility to processing facilities or markets. The truck access 510 may be configured to accommodate vehicles of various sizes, including delivery trucks for supplies and refrigerated trucks for fish transport.

In various embodiments, one or more transmission lines may extend from the powerhouse 300 to transmit generated electrical power to external distribution points. The one or more transmission lines may connect the powerhouse 300 to an electrical grid, enabling the PSH system to deliver stored energy to the grid during periods of high energy demand and to receive energy from the grid for pumping operations during periods of excess energy availability. The one or more transmission lines may be configured to accommodate the power output capacity of the powerhouse 300 and may include appropriate voltage transformation and protection equipment to ensure safe and reliable power transmission.

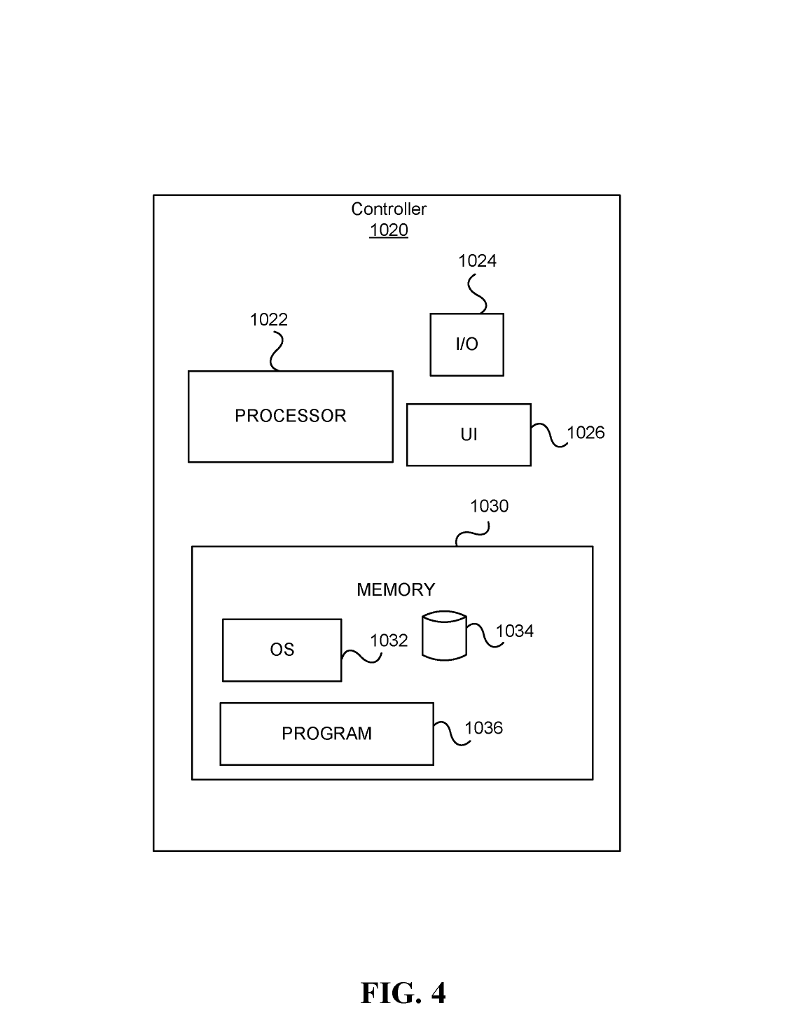

FIG. 4 illustrates an example controller 1020 configured to control at least a portion of the dual-use water management system. As shown, the controller 1020 may include a processor 1022, an input/output ("I/O") device 1024, a memory 1030 containing an operating system ("OS") 1032 and a program 1036. In certain example implementations, the controller 1020 may be a single server or may be configured as a distributed computer system including multiple servers or computers that interoperate to perform one or more of the processes and functionalities associated with the disclosed embodiments. In some embodiments, controller 1020 may be one or more servers from a serverless or scaling server system. In some embodiments, the controller 1020 may further include a peripheral interface, a transceiver, a mobile network interface in communication with the processor 1022, a bus configured to facilitate communication between the various components of the controller 1020, and a power source configured to power one or more components of the controller 1020.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth^{TM} port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth^{TM}, low-energy Bluetooth^{TM} (BLE), WiFi™, ZigBee^{TM}, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 1022 to communicate with other devices via wired or wireless networks, whether local or wide area, private or public, as known in the art. A power source may be configured to provide an appropriate alternating current (AC) or direct current (DC) to power components.

The processor 1022 may include one or more of a microprocessor, microcontroller, digital signal processor, co-processor or the like or combinations thereof capable of executing stored instructions and operating upon stored data. The memory 1030 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 1030.

The processor 1022 may be one or more known processing devices, such as, but not limited to, a microprocessor from the Pentium^{TM} family manufactured by Intel^{TM} or the Turion^{TM} family manufactured by AMD^{TM}. The processor 1022 may constitute a single core or multiple core processor that executes parallel processes simultaneously. For example, the processor 1022 may be a single core processor that is configured with virtual processing technologies. In certain embodiments, the processor 1022 may use logical processors to simultaneously execute and control multiple processes. The processor 1022 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the controller 1020 may include one or more storage devices configured to store information used by the processor 1022 (or other components) to perform certain functions related to the disclosed embodiments. In one example, the controller 1020 may include the memory 1030 that includes instructions to enable the processor 1022 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the controller 1020 may include a memory 1030 that includes instructions that, when executed by the processor 1022, perform one or more processes consistent with the functionalities disclosed herein. Methods, systems, and articles of manufacture consistent with disclosed embodiments are not limited to separate programs or computers configured to perform dedicated tasks. For example, the controller 1020 may include the memory 1030 that may include one or more programs 1036 to perform one or more functions of the disclosed embodiments.

The processor 1022 may execute one or more programs located remotely from the controller 1020. For example, the controller 1020 may access one or more remote programs that, when executed, perform functions related to disclosed embodiments.

The memory 1030 may include one or more memory devices that store data and instructions used to perform one or more features of the disclosed embodiments. The memory 1030 may also include any combination of one or more databases controlled by memory controller devices (e.g., server(s), etc.) or software, such as document management systems, Microsoft^{TM} SQL databases, SharePoint^{TM} databases, Oracle^{TM} databases, Sybase^{TM} databases, or other relational or non-relational databases. The memory 1030 may include software components that, when executed by the processor 1022, perform one or more processes consistent with the disclosed embodiments. In some examples, the memory 1030 may include a database 1034 configured to store various data described herein.

The controller 1020 may also be communicatively connected to one or more memory devices (e.g., databases) locally or through a network. The remote memory devices may be configured to store information and may be accessed and/or managed by the controller 1020. By way of example, the remote memory devices may be document management systems, Microsoft^{TM} SQL database, SharePoint^{TM} databases, Oracle^{TM} databases, Sybase^{TM} databases, or other relational or non-relational databases. Systems and methods consistent with disclosed embodiments, however, are not limited to separate databases or even to the use of a database.

The controller 1020 may also include one or more I/O devices 1024 that may comprise one or more user interfaces 1026 (e.g., user interface) for receiving signals or input from devices and providing signals or output to one or more devices that allow data to be received and/or transmitted by the controller 1020. For example, the controller 1020 may include interface components, which may provide interfaces to one or more input devices, such as one or more keyboards, mouse devices, touch screens, track pads, trackballs, scroll wheels, digital cameras, microphones, sensors, and the like, that enable the controller 1020 to receive data from a user.

In example embodiments of the disclosed technology, the controller 1020 may include any number of hardware and/or software applications that are executed to facilitate any of the operations. The one or more I/O devices 1024 may be utilized to receive or collect data and/or user instructions from a wide variety of input devices. Received data may be processed by one or more computer processors as desired in various implementations of the disclosed technology and/or stored in one or more memory devices.

In various embodiments, the dual-use water management system may use the controller 1020 to track and optimize the performance of the integrated PSH and aquaculture system. The controller 1020 may provide centralized monitoring and control capabilities that enable coordinated management of water flow, energy generation, water treatment, and aquaculture operations across the integrated system. In some embodiments, the controller may collect data from sensors, flow meters, level sensors, and other monitoring devices distributed throughout the system and may aggregate the collected data for analysis and display within a unified monitoring interface. In various embodiments, the controller 1020 may be configured to monitor water quality parameters including pH, turbidity, temperature, dissolved oxygen, and nutrient concentrations at various locations within the water flow pathways. In various embodiments, the controller 1020 may also monitor flow rates within conduits, penstocks, and water treatment systems to track water movement throughout the integrated system. The controller 1020 may monitor energy output from the powerhouse 300 during generation operations and may track energy consumption during pumping operations and water treatment processes.

In various embodiments, the controller 1020 may be further configured to monitor environmental impact parameters associated with operation of the integrated system. In some cases, the environmental monitoring may include measurement of water discharge quality, noise levels, and other parameters that may be subject to regulatory requirements or environmental permits. In one or more embodiments, the controller may also track water quality metrics that demonstrate compliance with water quality standards applicable to discharges from the aquaculture facility and from the PSH system. In some cases, the tracked water quality metrics may include temperature, dissolved oxygen, pH, turbidity, nutrient concentrations, and concentrations of other substances that are subject to discharge limits or water quality criteria.

In one or more embodiments, the controller 1020 may be configured to track water use and water balance metrics that demonstrate efficient use of water resources and minimal water loss within the closed-loop system. In some embodiments, the tracked water balance metrics may include volumes of water withdrawn from source waters, volumes of water circulated through the aquaculture facility, volumes of water returned to the PSH reservoirs, and volumes of water lost through evaporation or other mechanisms. The water balance tracking may support compliance with water rights, water use permits, or other regulatory requirements that govern water withdrawal and consumption.

In various embodiments, the controller 1020 may be further configured to track energy generation and consumption metrics that demonstrate compliance with grid interconnection requirements and energy market protocols. In one or more embodiments, the tracked energy metrics may include power output during generation operations, power consumption during pumping operations, response times to grid dispatch signals, and other parameters that are relevant to grid integration and energy market participation. The energy tracking may support compliance with requirements established by grid operators, energy regulators, or energy market administrators. In various embodiments, the controller 1020 may track aquaculture production metrics that demonstrate compliance with aquaculture permits and food safety requirements. In some cases, the tracked aquaculture metrics may include fish stocking densities, feeding rates, mortality rates, harvest volumes, and water treatment performance parameters that are relevant to aquaculture regulatory compliance. The aquaculture tracking may support compliance with permits issued by state or federal agencies that regulate aquaculture operations and may support food safety certifications that require documentation of production practices and environmental conditions.

In one or more embodiments, the controller 1020 may comprise a flow control mechanism to coordinate water distribution throughout the closed-loop circulation to ensure that both PSH and aquaculture operations receive adequate water supply. The controller may utilize one or more automated valves positioned at branch points within the water flow pathways, with the automated valves configured to regulate the volume and timing of water flow to each application. In some embodiments, the automated valves may be controlled by predictive algorithms that anticipate water distribution requirements based on operational schedules, demand forecasts, and environmental conditions.

In various embodiments, the controller 1020 may comprise one or more programs configured to be at least one predictive algorithm. In various embodiments, the at least one predictive algorithm may be incorporated into the flow control mechanism. In one or more embodiments, the at least one predictive algorithm may analyze multiple data inputs to determine appropriate water distribution configurations. In some embodiments, the at least one predictive algorithm may consider PSH operational schedules, including planned pumping and generation cycles, to anticipate periods when water flow through the penstock will be prioritized for energy operations. The at least one predictive algorithm may also consider aquaculture water requirements, including fish biomass, feeding schedules, and water quality trends, to anticipate periods when increased water flow to the aquaculture facility may be beneficial. The analysis of multiple data inputs may enable the at least one predictive algorithm to identify water distribution configurations that satisfy the requirements of both applications within available water resources.

In various embodiments, the at least one predictive algorithm may be configured to anticipate water distribution requirements based on operational schedules, demand forecasts, and environmental conditions. In some embodiments, the at least one predictive algorithm may analyze historical data regarding energy demand patterns, aquaculture water requirements, and PSH operational cycles to generate predictions of future water distribution needs. The at least one predictive algorithm may use these predictions to pre-position automated valves and adjust flow rates in advance of anticipated changes in operational requirements. Ine one or more embodiments, the at least one predictive algorithm may be configured to coordinate water distribution timing to ensure seamless integration of secondary uses without impacting the primary energy generation process. In various embodiments, the at least one predictive algorithm may schedule water delivery to the aquaculture facility during periods when PSH energy generation demand is lower, allowing the system to prioritize energy generation during peak demand periods. The at least one predictive algorithm may adjust the timing of water flow to the aquaculture facility based on real-time information regarding grid energy demand, renewable energy availability, and PSH operational status.

In one or more embodiments, the at least one predictive algorithm may include operational rules that prevent interference between PSH and aquaculture operations. In various embodiments, the operational rules may establish minimum water flow rates or reservoir levels that are maintained for PSH operations regardless of aquaculture water demands. The operational rules may define priority hierarchies that determine how water resources are allocated when simultaneous demands from PSH and aquaculture operations exceed available water supply capacity. In some embodiments, the operational rules may establish priority hierarchies that determine how water resources are allocated when simultaneous demands from both applications exceed available water supply capacity. The operational rules may define minimum water flow rates or reservoir levels that are maintained for PSH operations regardless of aquaculture water demands, ensuring that energy generation capacity is preserved during periods of high energy demand. The operational rules may also define minimum water flow rates for aquaculture operations that maintain fish health and production continuity during periods when PSH operations are prioritized. In various embodiments, the operational rules may include constraints that maintain minimum reservoir levels for PSH operations regardless of aquaculture water demands.

In various embodiments, the at least one predictive algorithm may incorporate machine learning techniques configured to improve prediction accuracy over time based on observed system behavior. In some embodiments, the at least one predictive algorithms may analyze correlations between environmental conditions, operational parameters, and water distribution outcomes to refine prediction models. The machine learning techniques may enable the flow control mechanisms to adapt to site-specific conditions and operational patterns that may not be fully captured by initial algorithm configurations.

In one or more embodiments, the controller 1020 may further comprise at least one feedback loop configured to monitor actual water flow rates and compare measured values against predicted or target values. In some embodiments, the at least one feedback loop may detect deviations between actual and predicted water flow and may adjust automated valve positions to correct the deviations. The at least one feedback loop may provide real-time adjustments to aquaculture water flow based on PSH operating constraints, ensuring continuous operation of both systems without conflict.

In various embodiments, the controller 1020 may be configured to monitor real-time data regarding water quality, flow rates, and reservoir levels throughout the integrated system. The real-time data may be used by the controller 1020 to adjust water distribution in response to changing conditions. In some embodiments, the controller 1020 may detect changes in water quality parameters that indicate the need for increased water flow to the aquaculture facility or increased treatment intensity within the water treatment systems. The controller 1020 may also detect changes in reservoir levels that indicate the need for adjustments to water distribution to maintain balanced reservoir levels for PSH operations. In one or more embodiments, controller 1020 may be configured to open, close, or modulate water flow based on control signals received from one or more sensors located throughout the system. In various embodiments, the controller 1020 may electrically actuate gate valves, butterfly valves, or ball valves to adjust water flow rates in real time.

In various embodiments, the controller 1020 may make real-time adjustments based at least in part on the real-time data. In various embodiments, the real-time adjustments may include reducing aquaculture water flow during periods when the PSH system is operating in generation mode and water flow through the penstock is prioritized for energy production. The real-time adjustments may enable continuous operation of both PSH and aquaculture systems by dynamically allocating water resources based on current operational requirements. In one or more embodiments, the controller 1020 may dynamically adjust flow rates to support efficient PSH operation and optimal conditions for aquaculture. In some embodiments, the controller 1020 may analyze real-time data from sensors and flow meters to determine appropriate flow rate adjustments that balance the requirements of both PSH and aquaculture operations. The dynamic flow rate adjustments may respond to changing conditions such as variations in energy demand, changes in aquaculture water quality, or fluctuations in reservoir levels.

While the controller 1020 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the controller 1020 may include a greater or lesser number of components than those illustrated.

### Example 1 – Dual-Use Water Management System

An exemplary embodiment of the present invention provides a dual-use water management system for integrating Pumped Storage Hydropower (PSH) with Recirculating Aquaculture Systems (RAS). The upper reservoir feeds water via penstock (e.g., conduit) to the inlet water treatment and subsequently to the aquaculture facility and the outlet water treatment and then the lower reservoir. Powerhouse is operably coupled to a power generator via line. Powerhouse can pump water from lower reservoir to upper reservoir and can generate power in reverse operation (from upper reservoir to lower reservoir). Water can also flow from the aquaculture facility directly into the penstock and back to the upper reservoir. In an exemplary embodiment, the upper reservoir is disposed at a higher elevation than both the aquaculture facility which is in turn at a higher elevation than the lower reservoir. The dual-use water management system can include an upper reservoir and a lower reservoir connected by one or more primary penstock(s) and a separate conduit system (e.g., at least one additional penstock) for water movement. The dual-use water management system can include a conduit to deliver gravity-fed water from the upper reservoir to an aquaculture facility, minimizing the need for additional energy inputs. The dual-use water management system can include a discharge system that treats and returns water from the aquaculture facility to the lower reservoir, ensuring minimal water loss and maintaining compatibility with PSH operations.

In the exemplary embodiment, the dual-use water management system can include a multi-use conduit and penstock system. The multi-use conduit and penstock system can include a multi-use conduit and penstock system configured to manage water flow for simultaneous energy generation and secondary uses including: one or more penstocks or conduits, flow control mechanisms to manage water distribution and timing, and flexible, modular conduit system that supports additional applications. The one or more penstocks or conduits can connect the upper reservoir to the powerhouse for energy generation and supply water to the aquaculture facility, supporting concurrent energy generation and fish production without operational conflicts. The flow control mechanisms can manage water distribution and timing, ensuring seamless integration of secondary uses without impacting the primary energy generation process. The flexible conduit system can support additional applications, such as cooling, without requiring significant modifications to the primary infrastructure.

In the exemplary embodiment, the dual-use water management system provides an energy efficiency and gravity-fed water system for managing water flow in aquaculture operations. The energy efficiency and gravity-fed water system can include a gravity-fed water system that delivers water from the upper reservoir to the aquaculture facility, using natural flow to provide circulation through the aquaculture infrastructure, thereby minimizing the need for energy-intensive pumping systems. The energy efficiency and gravity-fed water system can operate continuously, ensuring a consistent water supply to the aquaculture facility’s rearing ponds and/or tanks. The system can ensure integrated water flow management for aquaculture without interfering with or negatively impacting PSH energy generation activities.

In the exemplary embodiment, the dual-use water management system provides a water treatment and recirculation system configured for use in an integrated PSH and aquaculture facility. The treatment and recirculation system can include a closed-loop water treatment system that filters and purifies water exiting the aquaculture facility before returning it to the lower reservoir, reducing the potential for disease or pathogen spread. The water treatment and recirculation system can include processes and/or mechanisms for removing solids and other adulterants as needed, ensuring that returned water meets quality standards required for reuse in PSH energy generation. The water treatment and recirculation system can include efficiency features that support seamless integration within the PSH cycle, including minimal water loss, low electrical consumption, and recovery of valuable waste products, all contributing to sustainable operation with minimal environmental impact.

The dual-use water management system can be configured to be adaptable to PSH as a non-project use of land and water, such as aquaculture, without requiring significant reconfiguration of the primary energy infrastructure. The modular components can allow for scalable capacity adjustments to meet varying regional demands for energy generation, water flow, and fish production. The systems can include a water supply conduit that can be easily expanded or reconfigured to accommodate future changes in operational needs or secondary land and water applications.

The dual-use water management system can comprise an automated flow monitoring system for managing water distribution and quality between PSH and aquaculture. The automated flow monitoring system can include sensors that continuously monitor water quality parameters, such as pH, turbidity, temperature, and nutrient levels, to ensure conditions meet the requirements for aquaculture and PSH reuse. The automated flow monitoring system can include a means for monitoring water use and loss as well as tracking inflow and outflow to maintain efficient circulation and balanced reservoir levels. The automated flow monitoring system can include operational rules to prevent interference with PSH energy generation, including real-time adjustments to aquaculture water flow based on PSH operating constraints to ensure continuous operation of both systems without conflict. The automated flow monitoring system can include additional monitoring features that dynamically adjust flow rates and temperature to support efficient PSH operation and optimal conditions for aquaculture.

### Example 2 – Method For Low-Impact Environmental Installation

An exemplary embodiment of the present invention provides a method for low-impact environmental installation of any of the systems disclosed herein. The method can include ensuring compliance with federal, state, and local regulatory requirements, with the Recirculating Aquaculture System (RAS) facility considered a non-project use of land and water. The method can include implementing of low-impact installation measures, including but not limited to erosion control, sediment management, and habitat protection, to minimize ecological disruption. The method can include employing filtration and water treatment systems configured to maintain water quality suitable for both aquaculture habitat and Pumped Storage Hydropower (PSH) operational standards, ensuring clean water inflow for fish health and clean return water for PSH functionality. The method can include configuring any of the systems herein to meet environmental compliance requirements by tracking necessary metrics, ensuring alignment with regulatory and operational standards for sustainable energy and aquaculture operations.

The low-impact installation process method can be used for erosion control, sediment management, and habitat protection, with compliance to federal, state, and local regulatory standards (e.g., those set by the Federal Energy Regulatory Commission (FERC)). Filtration and water treatment systems ensure that water quality meets the needs of both aquaculture and PSH operations. These environmentally sensitive features enable sustainable deployment with minimal ecological disruption across diverse sites

### Example 3 – A Real-Time Supervisory Control and Data Acquisition (SCADA) Monitoring System

An exemplary embodiment of the present invention provides a real-time Supervisory Control and Data Acquisition (SCADA) monitoring system configured to track and optimize the performance of the integrated PSH/aquaculture system. The monitoring system can include sensors that continuously monitor critical parameters, including water quality, flow rates, energy output, and environmental impact, with adaptability for additional metrics as needed. A central control system can generate automated compliance reports for regulatory standards (e.g., FERC) and provide priority-based alerts for potential disruptions, enabling timely intervention to prevent system downtime or regulatory non-compliance. The monitoring system can include optimization features that analyze historical and real-time data to dynamically adjust operational parameters, such as flow rates and energy output, based on demand cycles, environmental conditions, and aquaculture requirements. This adaptive control can maximize resource efficiency and maintains ideal conditions for PSH and aquaculture operations.

The monitoring system can use predictive flow control algorithms to improve on traditional flow management systems. By dynamically adjusting water distribution based on demand cycles and environmental conditions, the system maintains optimal conditions for both PSH and aquaculture, preventing operational conflicts and maximizing resource efficiency. The integrated closed-loop water treatment system, which treats and returns water from the aquaculture facility to the PSH lower reservoir minimizes water loss and environmental impact, distinguishing it from conventional PSH systems that do not incorporate secondary water uses within a closed system.

The monitoring system can use real-time sensors and predictive algorithms to monitor water quality, flow rates, and reservoir levels, dynamically managing water distribution across PSH and secondary applications. Operational procedures can ensure non-interference with PSH energy generation, allowing the system to optimize conditions for both primary and secondary uses in response to changing demand cycles and environmental factors.

The disclosed technology can be further understood according to the following clauses:

Clause 1: A dual-use water management system comprising: an upper reservoir at a first elevation; a lower reservoir positioned at a second elevation lower than the upper reservoir; a powerhouse in fluid communication with the upper reservoir and the lower reservoir via at least one penstock, the powerhouse configured to pump water from the lower reservoir to the upper reservoir and to generate power from water flowing from the upper reservoir to the lower reservoir by directing water through a turbine to drive a generator; and an aquaculture facility positioned at a third elevation between the upper reservoir and the lower reservoir and in fluid communication with the upper reservoir, lower reservoir, and powerhouse, the aquaculture facility being configured to maintain water quality parameters suitable for aquatic life.

Clause 2: The dual-use water management system of Clause 1, further comprising a water treatment system in fluid communication with the upper reservoir, lower reservoir, and the powerhouse.

Clause 3: The dual-use water management system of Clause 2, wherein the water treatment system comprises a closed-loop water treatment system that filters and purifies water exiting the aquaculture facility before returning the treated water to the lower reservoir.

Clause 4: The dual-use water management system of Clause 3, wherein the water treatment system comprises processes for removing solids and other adulterants from the water.

Clause 5: The dual-use water management system of Clause 2, wherein the water treatment system is configured to process water from the upper reservoir before the water enters the aquaculture facility.

Clause 6: The dual-use water management system of Clause 2, wherein the water treatment system is configured to filter water exiting the aquaculture facility before returning it to the lower reservoir.

Clause 7: The dual-use water management system of Clause 2, wherein the water treatment system is configured to prevent a spread of disease and/or pathogens.

Clause 8: The dual-use water management system of Clause 1, wherein the aquaculture facility comprises rearing ponds or tanks configured to maintain water quality parameters.

Clause 9: The dual-use water management system of Clause 1, further comprising flow control mechanisms configured to manage water distribution and timing between the upper reservoir, the aquaculture facility, and the powerhouse.

Clause 10: The dual-use water management system of Clause 9, wherein the flow control mechanisms comprise automated valves and are controlled via predictive algorithms configured to coordinate water flow throughout the dual-use water management system.

Clause 11: The dual-use water management system of Clause 10, wherein the predictive algorithms are configured to dynamically adjust water distribution based on real-time demand and environmental conditions.

Clause 12: The dual-use water management system of Clause 1, further comprising at least one sensor configured to continuously monitor water quality parameters including at least one of pH, turbidity, temperature, nutrient levels, or a combination thereof.

Clause 13: The dual-use water management system of Clause 12, wherein the at least one sensor is further configured to monitor at least water use, water loss, inflow, outflow, or a combination thereof.

Clause 14: The dual-use water management system of Clause 1, wherein the at least one penstock is configured, along with one or more flow control mechanisms, for controlling at least one of water distribution, timing, cooling, or a combination thereof.

Clause 15: The dual-use water management system of Clause 1, further comprising at least one additional penstock configured to be used in at least one additional reservoir or aquaculture center.

Clause 16: An automated flow monitoring system for managing water distribution comprising: a plurality of sensors configured to continuously monitor water quality parameters; a flow meter configured to track water inflow and outflow to maintain balanced levels in an upper reservoir at a first elevation, a lower reservoir at a second elevation lower than the first elevation, and an aquaculture center at a third elevation between the first elevation and the second elevation; and a control system configured to implement operational rules for controlling (1) water flow for pumped storage hydropower energy generation and (2) water filtration for maintaining water quality parameters suitable for aquatic life, the control system configured to dynamically adjust flow rates based on demand cycles, environmental conditions, and aquaculture requirements.

Clause 17: The automated flow monitoring system of Clause 16, wherein the water quality parameters include at least one of a pH, turbidity, temperature, nutrient levels, or a combination thereof in the upper reservoir, the lower reservoir, and the aquaculture center.

Clause 18: The automated flow monitoring system of Clause 16, wherein the control system comprises automated valves controlled via predictive algorithms configured to coordinate water flow throughout the upper reservoir, the lower reservoir, and the aquaculture center.

Clause 19: The automated flow monitoring system of Clause 18, wherein the predictive algorithms are configured to dynamically adjust water distribution based on real-time demand and environmental conditions.

Clause 20: The automated flow monitoring system of Clause 16, wherein the flow meter is further configured to output data for monitoring water user and water loss in the upper reservoir, the lower reservoir, and the aquaculture center.

Stated simply, the modular PSH system is adapted to support sustainable fish production alongside energy storage. Water from the upper reservoir is gravity-fed to the aquaculture facility, where it circulates through rearing ponds or tanks that maintain optimal water quality and nutrient levels for fish health. This configuration leverages real-time monitoring systems to continuously track water parameters, including pH, turbidity, and nutrient concentrations, ensuring an ideal environment for aquaculture. Upon exiting the aquaculture facility, water passes through a closed-loop treatment and filtration system to remove solids, impurities, and pathogens. The treated water is then returned to the lower reservoir, where it can be pumped back to the upper reservoir in alignment with PSH operations. This closed-loop approach supports both PSH and aquaculture needs without water loss, minimizing environmental impact and complying with regulatory standards for sustainable operations. The aquaculture configuration demonstrates the dual-use capability of the PSH system, maximizing resource efficiency by integrating food production with energy storage. This setup is particularly well-suited for regions seeking both renewable energy solutions and local food production infrastructure, providing community and economic benefits within a single, adaptable system.

The system is configured to be adaptable to PSH as a non-project use of land and water, such as aquaculture, without requiring significant reconfiguration of the primary energy infrastructure. Features such as real-time monitoring, environmental protection measures, and closed-loop water management ensure adherence to FERC’s operational, safety, and environmental requirements for hydropower facilities. These measures facilitate a streamlined permitting process, reducing regulatory barriers and expediting deployment within U.S. jurisdictions.

The modular configuration also supports adaptability for international and non-FERC-regulated environments. Its scalable and environmentally sensitive approach allows for compliance with various regional and national standards, making it viable for deployment in diverse regulatory contexts. The system’s low-impact installation and continuous water quality monitoring meet a broad range of compliance requirements, ensuring its suitability for both public and private sector projects globally.

To restate some of the benefits of the systems and methods disclosed herein, this disclosures modular and scalable configuration enables multiple water applications within a single PSH system, integrating energy storage and aquaculture in a way that conventional PSH systems cannot. This dual-use configuration expands the operational utility of PSH infrastructure for sustainable food production and other water uses.

By integrating energy storage with sustainable food production, this disclosure provides a dual-use solution that directly supports food and energy security—a top priority for communities and national goals alike. The ability to store renewable energy and produce food within a single infrastructure enhances regional resilience, meeting demand for both critical resources. This is a sustainable approach to resource management that strengthens food supply chains and ensures reliable energy availability, especially in underserved or transition regions.

With its dual-use functionality, this system maximizes land use efficiency by supporting energy storage and food production on the same footprint, reducing the need for separate facilities. This consolidated approach minimizes ecological disruption, allowing for low-impact installation and operation, and aligning with environmental goals for sustainable land and water resource management. The closed-loop configuration reduces water loss, protects local ecosystems, and supports long-term ecological health.

This disclosure addresses national priorities by advancing renewable energy storage solutions and contributing to sustainable food production. By utilizing a modular and adaptable PSH design, the system promotes decarbonization and helps integrate renewable energy into the grid, supporting national climate goals. Simultaneously, it advances food security by facilitating local aquaculture, reducing reliance on distant food sources, and promoting sustainable agriculture practices within an energy-resilient framework.

The dual-use nature of the system supports local job creation and economic development by fostering industries in renewable energy and aquaculture. This generates opportunities for a skilled workforce in energy management, aquaculture, and environmental monitoring, promoting jobs that support both local communities and regional economies.

Restating simply some of the features of the present disclosure, the present disclosure includes a dual-use water management system designed to integrate Pumped Storage Hydropower (PSH) with Recirculating Aquaculture Systems (RAS). The system can include an upper reservoir and a lower reservoir, connected by primary penstock(s) or channels and a dedicated conduit system that allows for targeted water movement between the PSH and RAS operations. Water is gravity-fed from the upper reservoir to the aquaculture facility through a separate conduit, reducing reliance on energy-intensive pumping mechanisms. This gravity-fed aquaculture operation leverages the natural elevation differences within the PSH system to efficiently deliver water, enabling energy savings and sustainable aquaculture operation.

The system can also feature a discharge mechanism that treats and returns water from the aquaculture facility to the lower reservoir. Filtration and purification processes within the discharge system remove impurities and pathogens, ensuring that the water meets PSH operational standards before it is returned to the lower reservoir. This closed-loop configuration minimizes water loss and maintains compatibility between the aquaculture and PSH functions, allowing for seamless dual use without compromising either operation.

The system can include a multi-use conduit and penstock system. The multi-use conduit and penstock system can optimize water flow distribution for both primary energy generation and secondary uses. Flow control mechanisms, including automated valves and predictive algorithms, manage timing and distribution to each application, ensuring continuous operation without conflicts. These controls dynamically adjust flows based on real-time demand and environmental conditions, allowing the system to prioritize PSH energy storage or aquaculture needs as required.

The conduits can be configured to accommodate additional applications, such as industrial cooling, without requiring substantial infrastructure modifications. This flexible architecture allows the system to scale according to site-specific needs, maximizing resource efficiency and supporting a range of sustainable water uses within a unified structure.

The system can also include a water treatment and filtration mechanism. To support sustainable dual-use functionality, the system incorporates a closed-loop water treatment and filtration mechanism that ensures water quality standards are maintained for both PSH and aquaculture operations. The filtration system is designed to remove impurities, solids, and potential pathogens as water exits the aquaculture facility, aligning with regulatory standards and protecting both fish health and PSH operations.

This filtration mechanism is adaptable, with customizable treatment stages to meet site-specific water quality and environmental requirements. By returning treated water to the lower reservoir, the system minimizes water loss, reduces the need for additional makeup water, and enhances resource efficiency, all within a closed-loop design that supports sustainable operation and reduces ecological impact.

The water treatment and filtration mechanism can be configured to carry out filtration cycles subservient to the power generation and storage needs of the PSH facility and other components of the system to efficiently utilize power from a generation source.

The system can feature modular components to facilitate site-specific expansion and reconfiguration as well as enable adjustments to meet changes in energy and water demand while supporting secondary applications. The system is designed for long-term durability across diverse operational environments, reducing maintenance needs and extending operational life.

While certain examples of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A dual-use water management system comprising:
an upper reservoir at a first elevation;
a lower reservoir positioned at a second elevation lower than the upper reservoir;
a powerhouse in fluid communication with the upper reservoir and the lower reservoir via at least one penstock, the powerhouse configured to pump water from the lower reservoir to the upper reservoir and to generate power from water flowing from the upper reservoir to the lower reservoir by directing water through a turbine to drive a generator; and
an aquaculture facility positioned at a third elevation between the upper reservoir and the lower reservoir and in fluid communication with the upper reservoir, lower reservoir, and powerhouse, the aquaculture facility being configured to maintain water quality parameters suitable for aquatic life.

2. The dual-use water management system of claim 1, further comprising a water treatment system in fluid communication with the upper reservoir, lower reservoir, and the powerhouse.

3. The dual-use water management system of claim 2, wherein the water treatment system comprises a closed-loop water treatment system that filters and purifies water exiting the aquaculture facility before returning the treated water to the lower reservoir.

4. The dual-use water management system of claim 3, wherein the water treatment system comprises processes for removing solids and other adulterants from the water.

5. The dual-use water management system of claim 2, wherein the water treatment system is configured to process water from the upper reservoir before the water enters the aquaculture facility.

6. The dual-use water management system of claim 2, wherein the water treatment system is configured to filter water exiting the aquaculture facility before returning it to the lower reservoir.

7. The dual-use water management system of claim 2, wherein the water treatment system is configured to prevent a spread of disease and/or pathogens.

8. The dual-use water management system of claim 1, wherein the aquaculture facility comprises rearing ponds or tanks configured to maintain water quality parameters.

9. The dual-use water management system of claim 1, further comprising flow control mechanisms configured to manage water distribution and timing between the upper reservoir, the aquaculture facility, and the powerhouse.

10. The dual-use water management system of claim 9, wherein the flow control mechanisms comprise automated valves and are controlled via predictive algorithms configured to coordinate water flow throughout the dual-use water management system.

11. The dual-use water management system of claim 10, wherein the predictive algorithms are configured to dynamically adjust water distribution based on real-time demand and environmental conditions.

12. The dual-use water management system of claim 1, further comprising at least one sensor configured to continuously monitor water quality parameters including at least one of pH, turbidity, temperature, nutrient levels, or a combination thereof.

13. The dual-use water management system of claim 12, wherein the at least one sensor is further configured to monitor at least water use, water loss, inflow, outflow, or a combination thereof.

14. The dual-use water management system of claim 1, wherein the at least one penstock is configured, along with one or more flow control mechanisms, for controlling at least one of water distribution, timing, cooling, or a combination thereof.

15. The dual-use water management system of claim 1, further comprising at least one additional penstock configured to be used in at least one additional reservoir or aquaculture center.

16. An automated flow monitoring system for managing water distribution comprising:
a plurality of sensors configured to continuously monitor water quality parameters;
a flow meter configured to track water inflow and outflow to maintain balanced levels in an upper reservoir at a first elevation, a lower reservoir at a second elevation lower than the first elevation, and an aquaculture center at a third elevation between the first elevation and the second elevation; and
a control system configured to implement operational rules for controlling (1) water flow for pumped storage hydropower energy generation and (2) water filtration for maintaining water quality parameters suitable for aquatic life, the control system configured to dynamically adjust flow rates based on demand cycles, environmental conditions, and aquaculture requirements.

17. The automated flow monitoring system of claim 16, wherein the water quality parameters include at least one of a pH, turbidity, temperature, nutrient levels, or a combination thereof in the upper reservoir, the lower reservoir, and the aquaculture center.

18. The automated flow monitoring system of claim 16, wherein the control system comprises automated valves controlled via predictive algorithms configured to coordinate water flow throughout the upper reservoir, the lower reservoir, and the aquaculture center.

19. The automated flow monitoring system of claim 18, wherein the predictive algorithms are configured to dynamically adjust water distribution based on real-time demand and environmental conditions.

20. The automated flow monitoring system of claim 16, wherein the flow meter is further configured to output data for monitoring water user and water loss in the upper reservoir, the lower reservoir, and the aquaculture center.
